(19) United States
(12) Patent Application Publication
(10) Pub. No.: US 2004/0225659 A1
(43) Pub. Date: Nov. 11, 2004

(54) Storage foundry

(76) Inventors: John O'Brien, Short Hills, NJ (US); Nikita Shulga, Chernogolovka (RU)

Correspondence Address: RICHARD MILLMAN, 973 SPENCER ROAD, McLEAN, VA, 22102, US

(21) Appl. No.: 10/841,713

(22) Filed: May 7, 2004

Related U.S. Application Data
(60) Provisional application No. 60/469,188, filed on May 9, 2003.

(51) Int. Cl. G06F 17/30

(52) U.S. Cl. 707/9

(57) ABSTRACT

A data storage system utilizes information about the size and composition of the storage elements so as to permit expansion and contraction of the storage system on the fly. File statistics and the details of volume organization are coordinated making the management of user capacities, costs, and usage considerably easier. Segmented journals are used to permit recovery from system crashes, or unexpected power losses, to be directed to the respective lost areas.

### CROSS REFERENCE TO RELATED APPLICATIONS

This application claims priority under 35 U.S.C. § 119(e) from provisional application No. 60/469,188, filed May 9, 2003. The 60/469,188 provisional application is incorporate by reference herein, in its entirety, for all purposes.

### BACKGROUND

The present invention relates generally to the field of data storage. More specifically, the present invention relates to a system and method for improving data storage efficiency in a network accessible storage system.

It has been suggested that storage should be considered “the third pillar of IT infrastructure.” In this view, storage is as crucial in the design and deployment of any IT systems, as the core computing and networking technologies. To create this infrastructure requires highly sophisticated integration of the function of storage, the function of processing, and the function of networking.

This integration happens on different levels: macroscopic and microscopic. It can be best explained by looking at storage from the perspective of the marketplace (macroscopic level) and at a functional level (microscopic view).

When corporate users plan usage demands for a storage product, they have a variety of expectations concerning data availability, performance levels on that availability, and ease of expansion/contraction of that storage capacity. The corporate administrators of that storage capacity, will have their own expectations as to fault tolerance, online repairs, ease of configuration and management, and the necessary training requirements. Under such diverse expectations, storage is indeed a concept—as indeed is telephone service for an organization. Both may be facilitated by tangible pieces of equipment and various service providers. The customer makes those purchases to meet his or her identified conceptual needs.

In an ideal environment, decisions regarding storage will be made not solely on how much data can be stored, nor how fast data can be stored, but on how the storage is to be manage and how that storage bonds into the organization's long term technological architecture plans. Organizations need to manage data today, but they need to do that within the context of an architectural roadmap. In selecting a storage product, it is important to recognize that storage has evolved into an independent entity with a range of characteristics that can be, and needs to be, separately managed.

Market factors that drive storage selection comprise the following:

Failure free storage (from the user's perspective) All failures must be un-observed from the user's viewpoint (a minor degradation in performance is acceptable while repair takes place).

Storage that can easily be scaled—in either direction.

Storage that can be maintained without any downtime.

Storage that has as little and as infrequent perceived maintenance as possible.

As most maintenance actions are related to changing user requirements, the market wants all of these user requirements satisfied without downtime and as easily as possible.

Storage that can be monitored remotely.

Storage that can be maintained remotely consistent with the above objectives.

Storage that automatically backs up without downtime or performance penalties.

Storage that can recreate any prior state of any file system volume (or file) at any time.

Storage that can be shared by multiple host connections.

Functionally, storage is an element of a process. FIG. 1a illustrates the inter-process steps in the communication of an Input/Output operation of a standard network accessible storage (NAS) device according to the current art. Referring to FIG. 1a, a typical client platform communicates with a standard NAS appliance type of device. At the appliance side, action goes through the NIC (Network Interface Card), processed through the TCP/IP stack, and then the particular network protocol NFS (Network File System) or CIFS (Common Interface File System) is used to further decode and transmit the data. At this point the NAS OS orchestrates the data using the standard file system and standard volume manager. Finally, the selected data is formatted by the device driver, channeled through the host bus adapter, and travels through the 10 cable to the storage device itself.

Please note the shaded areas of the lower portion, which correspond to the standard file system and standard volume manager. These two areas—more than any other parts of this process—directly control and manage stored data. Yet, historically, these two processes have had rigidly defined and constrained ways of communicating with each other. Often, these two pieces of software are written and produced by different companies.

The file system primary function is to maintain a consistent view of storage so that storage can be managed in ways that are useful to the user. At its most basic level, the file system allows the users to create files and directories as well as delete, open, close, read, write and/or extend the files on the device(s). File systems also maintain security over the files that they maintain and, in most cases, access control lists for a file.

Initially, the file systems were limited to creating a file system on a single device. The volume manager was developed to enable the creation and management of file systems larger than a single disk. This advance allowed for larger and more efficient storage systems.

Today, the purpose of the file system is to allocate space and maintain consistency. The volume manager constructs and maintains an address allocation table used by the file system to allocate storage. The volume manager translates these addresses to the address of a particular storage device. The file system is not charged with knowing the topology of the storage system or making decisions based on this topology.

What would be useful would be a storage system that would utilize more information about the size and composition of the storage elements that the volume manager was managing so as to permit expansion and contraction of the storage system on the fly. Additionally, the usage of file statistics and the details of volume organization could be more closely coordinated making the management of user capacities, costs, and usage considerably easier. Such system would allow the use of segmented journals to allow recovery from system crashes, or unexpected power losses, to be directed to the respective lost areas. Additionally, the system would make backup and archiving operations more easily schedulable and managed. And such a system would be agnostic to the storage elements in which data is ultimately stored.

### DESCRIPTION OF THE DRAWINGS

FIG. 1a illustrates an Input/Output operation of a standard network accessible storage (NAS) device according to the current art.

FIG. 1b illustrates an Input/Output operation of a NAS device using a storage optimized file system with integrated volume manager according to an embodiment of the present invention.

FIG. 2 illustrates the I/O operation of FIG. 1 in which a Hierarchical Storage Management (HSM) facility is deployed according to an embodiment of the present invention.

FIG. 3 illustrates a storage foundry according to an embodiment of the present invention.

### DETAILED DESCRIPTION

The description of the present invention that follows utilizes a number of acronyms the definitions of which are provided below for the sake of clarity and comprehension.

ACL—Access Control List

ATA—Advanced Technology Attachment

CIFS—Common Interface File System

DDM—Data Delivery Manager

DOM—Data Organization Manager

DPM—Data Protection Manager

DWC—Device WRITE Cache

EA—Extended Attribute

HBA—Host Bus Adapter

HSM—Hierarchical Storage Management

I/O or IO—Input/Output

IDE—Integrated Development Environment

IFS—Interwoven File System

IOPs—Input Output Operations per second

iSCSI—Internet Small Computer System Interface

LAN—local area network

LFS—Large File Support

LVM—Logical Volume Manager

MB/s—Megabytes per Second

NAS—Network Accessible Storage

NFS—Network File System

NIC—Network Interface Card

OS—Operating System

RAID—Redundant Array of Independent Disks

SAN—Storage Area Network

SCSI—Small Computer System Interface

SNMP—Simple Network Management Protocol

SSU—Secondary Storage Unit

TCP/IP—Transmission Control Protocol—Internet Protocol

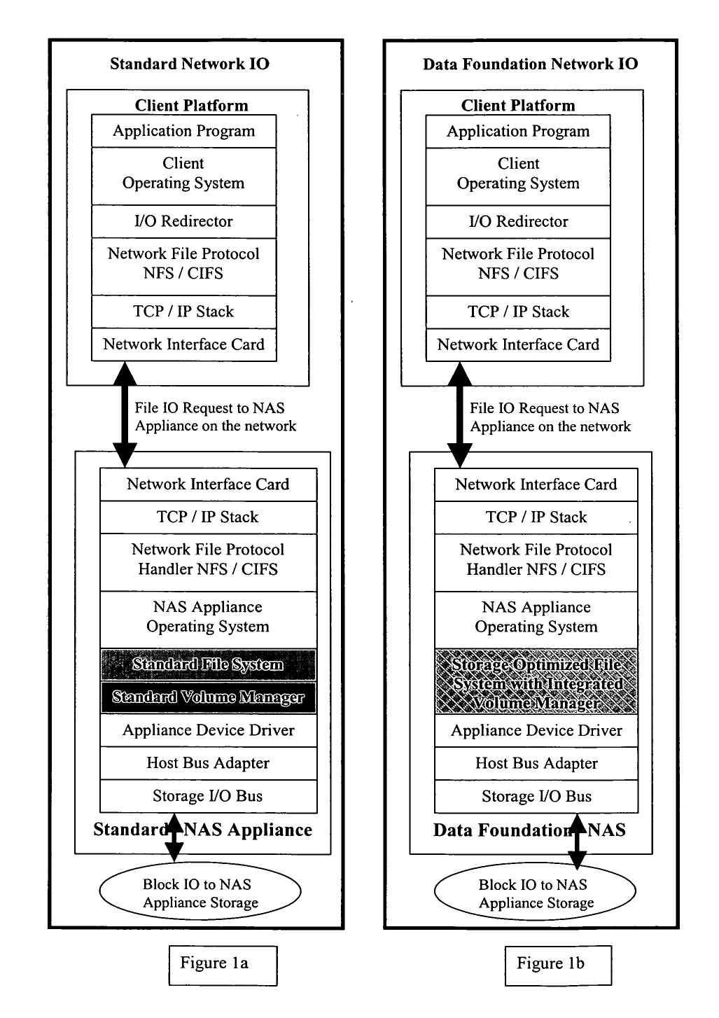

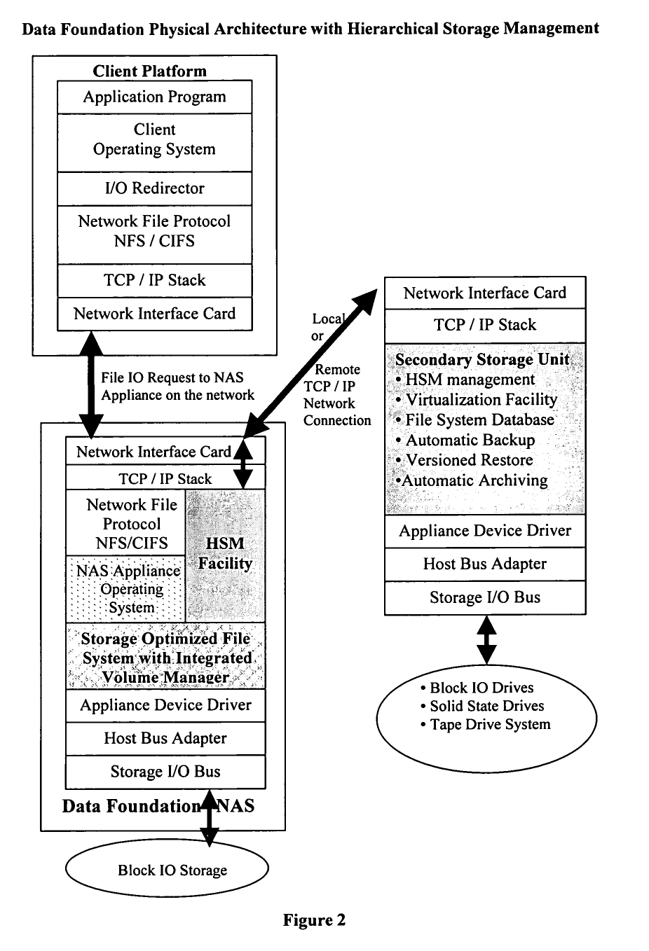

FIG. 1b illustrates an Input/Output (I/O) operation of a NAS device using a storage optimized file system with an interwoven file system (IFS) and volume manager according to an embodiment of the present invention. FIG. 2 illustrates the I/O operation of FIG. 1b in which a Hierarchical Storage Management (HSM) facility is deployed according to an embodiment of the present invention. Hierarchical Storage Management (HSM) has been a proven storage concept for some time. It is usually associated with mass storage systems. In an embodiment of the present invention, HSM capability is integrated into a scalable architectural feature that can be economically enjoyed from mid-sized to larger installations. Additionally, this HSM capability compensates for the normally slower speeds of the HSM resources.

The HSM facility of this embodiment operates in conjunction with the optimized file system with integrated volume manager. As such, the HSM has a full “appreciation” of file system volumes, their organization and boundaries, as well as access to the file system layout. In this embodiment, the HSM communicates with a Secondary Storage Unit (SSU) by formatting data through the TCP/IP stack and sending the data through the network card.

The Secondary Storage Unit (SSU), which may be either local or remote as it links via TCP/IP, represents a complementary control point to the HSM facility. The SSU is responsible for implementing some of the HSM functions. In one embodiment of the present invention, these functions comprise performing HSM management, managing a virtualization facility, managing a file system database, and managing automatic mirroring, backup and archiving process. Each of these functions is defined in more detail below.

HSM management: the HSM management portion of the SSU represents the operational and control arm of the HSM facility.

Virtualization Facility: as stored files in the NAS exceed any longevity dates set by the users, these files are automatically virtualized and are sent to the secondary device. Users control the time periods and the extent of which files are virtualized. This virtualization is transparent to the host(s). In addition, it is possible to retain a percentage of the file in the NAS primary area so that the performance appears as if the file is 100% present. (By way of illustration and not as a limitation, in a video on demand installation:, 10% of each movie could be ready on magnetic memory while the remaining 90% could have been virtualized to tape cartridge.)

File System Database: this database extends the associated NAS file system by keeping track of any file revisions that need to be logged to satisfy a user requested or default policy declaration. This is used by the Restore functionality.

Automatic Mirroring, Backup and Archiving: requests for automatic backup by users or administrators will be honored between the HSM and SSU and stored on a SSU controlled device. For small systems, it is possible to co-locate the SSU function and the NAS functions in the same unit.

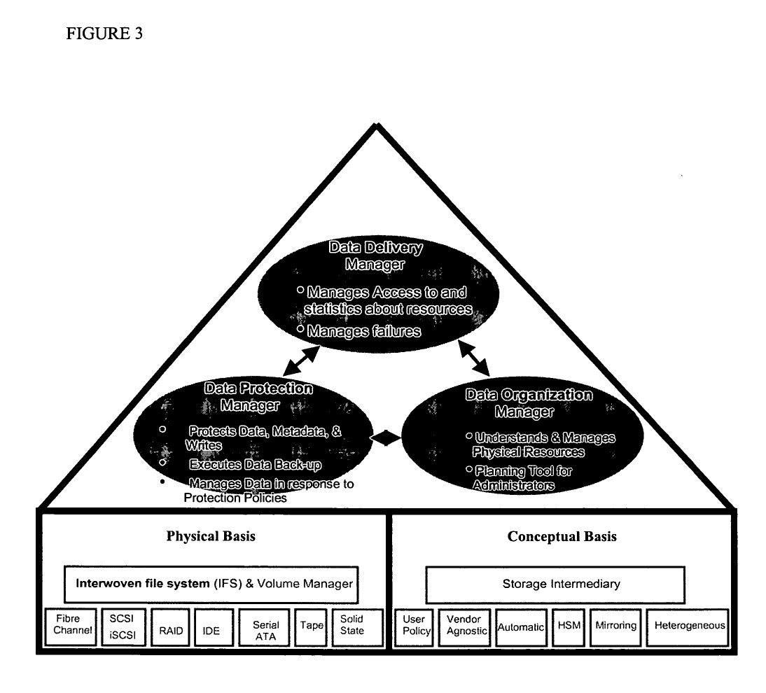

In another embodiment of the present invention, a storage foundry comprises an interwoven file system (IFS) and volume manager under the control of storage management software. The storage management software comprises three components: a Data Protection Manager (DPM), a Data Organization Manager (DOM), and a Data Delivery Manager (DDM). In this embodiment, data is managed at three levels: (i) the aggregate level, the (ii) file system volume level, and the (iii) file level. Across each level, storage is managed physically, logically, and topologically, via access control ability, automatically, and remotely. The storage foundry is illustrated in FIG. 3.

The DPM acts on a protection policy communicated by the administrator on behalf of users. Using this protection policy, the DPM insures that data is protected. Protection can be provided on a file system volume-by-volume basis, or on a file basis. This protection may be mirroring, or simple RAID level (directed to a physical RAID component), or involve an off-site backup. This applies to data as well as Metadata. The DPM also insures special protection for WRITEs until they are safely stored according to the protection policy. The DPM is responsible for:

Protecting all user data.

Protecting all associated metadata.

Protecting all writes that are acknowledged to any connected (or switched or networked) host and, once acknowledged, the DPM can assure that acknowledged/written data is never, ever unavailable.

Using a user specified protection policy criteria and back up criteria.

Managing data—on either a file system volume or file basis. Writes may be protected by being logged, mirrored, journaled, stored on a RAID device, remotely mirrored (asynchronously or synchronously), replicated (many-to-one or one-to-many), or backed-up (similar or different media).

Managing protected data in response to protection policy input (including default criteria).

Managing the back-up and backview according to protection polices for the users.

The DOM manages associated storage resources, which includes expansions and contractions. The DOM is where the physical storage resources are understood, configured, reconfigured and managed in accordance with both the physical requirements of the physical components (tapes, drives, solid state disk) and the user's (administrator's) input criteria. The DOM monitors and retains status of how full these resources are, and keeps track of any maintenance schedules, etc. The DOM can be used by administrators as a planning tool to: (1) manage storage assets better, (2) warn when capacity utilization reaches a critical level, (3) provide projections about capacity utilization, (4) identify the location of physical storage assets, (5) track performance management of individual assets, and (6) identify under utilized assets. The DOM performs the following tasks:

Collects and stores data on collectively managed storage resources (capacity, capacity utilization, location, usage statistics—in the aggregate, performance delivered, and maintenance schedules) so that system planning is facilitated.

Uses stored information about objects collected by the DDM.

The DDM is the back end resource that tracks and manages individual data accesses. Using the data collected by the DDM it is possible to: (1) track users (or resource level) “costs” of resource consumption, (2) provide failure histories on a component basis, and (3) measure and deliver requested performance responses. Note that the needs of the user, System Administrators, IT facility manager are all served by the collection of the three components described. DDM allows data to be physically, logically, and virtually stored, staged, and accessed. The data is represented to the respective host computer(s) as being stored. The DDM:

Uses specified performance policy criteria to control Storage resources (files, file system volumes, data pools comprised of a plurality of devices) that are understood and managed in terms of access control, access trails, etc.

Manages failure events

Collects and stores data on individually managed storage objects (size, date created, time since last access, owner) so that system planning is facilitated.

Prior art systems of data storage can determine the gross capacity of their storage elements and possibly the physical device type. They accomplish this in response to a SCSI level “get-device-type” or “probe SCSI” command, or equivalent. The latter type of command is a system level call and is not associated with the real time operation of a prior art file system. Prior art storage systems are simply unable to determine the specific device characteristics when attempting to store an individual file or a portion thereof. The present invention, due to the interwoven file system (IFS) and volume manager, is constantly aware of all physical devices as viewed from the conventional perspectives of both the volume manager level as well as the file system level. Accordingly, the present invention enables monitoring all individual user activity and calculating and tracking the costs of storage use, including financial as well as performance. Most significantly, this monitoring can be achieved down to the individual drive element level. This invention could provide for storage use to be calculated and tracked even down to an individual storage transfer.

In addition, it is possible to measure and track the performance of a user's storage experience using whatever storage elements that user has requested or been assigned. This also makes it possible to determine the likely performance of a future storage experience, using various storage parameters. As to prior experiences, the system could give actual data as measured. With respect to potential future storage use, the system can provide collected and extrapolated performance data to project potential system performance based on a particular configuration.

The present invention is also capable of projecting the performance of using various specified devices. In this way, the user can request a specific amount of storage at a particular IOPs (Input Output Operations per second) rate, or at a particular MB/s (Megabytes per Second) rate. The system of the present invention can respond to a requested configuration with a proposed list of existing available devices, a suggestion for additional or different storage resources to achieve the required requested performance level. These additional resources might be an increase in speed in the currently used drive elements, or an increase in the number of drive elements, or both. Those skilled in the art will recognize that there are a range of perturbations of a configuration (number of drive elements, performance ability of the drive elements, number of HBAs, speed of network connections, etc.) that might be perturbed in order to achieve the desired satisfactory level of performance.

At any given time, the system of the present invention “knows” the scope of available devices and storage and cost characteristics of each as maybe maintained in a database or table or some kind of accessible methodology. At any time, statistics on physical devices can be gathered directly by the system, based on the system's measuring of actual usage. Details on storage characteristics can be input into the system of the present invention by multiple methods, including a table entry, accepting data from a spreadsheet, accepting online entries, or any other data entry method now known or later developed.

The system of the present invention has the capability to (1) calculate, (2) estimate, (3) remember, and (4) suggest different storage configurations:

It can calculate storage characteristics such as, monetary costs, performance details, and current utilization.

It can estimate the monetary costs for specified performance details; alternatively, it can estimate performance details for specified monetary costs.

It can remember details of specific storage configurations. These may be existing configurations or configurations of the past. These are stored in a database for use in reports and estimations.

It can suggest configuration alternatives based on the concepts of scaling. It can suggest increases in the speed of drives, the number of drives, the quantity of drives on a specific bandwidth attachment, the type of drives (magnetic, solid state).

As will be apparent to those skilled in the art, the foregoing examples are not meant to be limiting. The device data known to the system of the present invention may be used for other purposes without departing from the scope of the present invention. This valuable data from the above four points can be organized and presented in any user or administrator selected manner. This valuable data may in multiple forms including graphs, spreadsheets, periodic reports, or in a response to a specific inquiry. In addition, a user or administrator may designate storage media based on desired characteristics such as price, speed, reliability, or space constraints.

The system of the present invention is also capable of determining monetary costs and performance information of any requested and accessible storage media or medium, and actually allocate and make accessible that storage medium or media.

FIG. 3 illustrates a storage foundry according to an embodiment of the present invention. The storage foundry comprises file system and a volume manager under the control of storage management software. The storage management software comprises three components: a Data Protection Manager (DPM), a Data Organization Manager (DOM), and a Data Delivery Manager (DDM). The storage foundry manages data exchanged with a collection of diverse resources with varying capabilities. By way of illustration and not as a limitation, these may include any magnetic memory based block addressable storage device (Fibre channel, SCSI, iSCSI, any commercial RAID product, IDE, serial ATA) tape, and solid-state drives. These resources may be from a variety of different vendors. On top of these diverse storage elements, is an interwoven file system (IFS) and volume manager. Parallel to the storage elements, the foundry supports a range of user defined storage policies, Hierarchical System Management (HSM) and mirroring among and between the resources. The foundry is vendor agnostic and delivers a consistent set of storage features for all users across equipment supplied by various vendors. This means that the users/administrators always see a common interface and are not subjected to a variety of training requirements. The operation of these benefits is automatic and is derived from the users/administrators declared protection and management policies.

As illustrated in FIG. 3, the Data Delivery Manager manages both the Data Protection Manager and the Data Organization Manager. In one perspective, the foundry represents a business concept functioning as a storage utility.

In order to illustrate the present invention, an exemplary embodiment of the present invention is described below. The exemplary embodiment is described in terms of the features of a Storage Foundry (and the terms may be use interchangeably). However, this description is not meant as a limitation.

The exemplary embodiment comprises an Access Control List (ACL) that allows the Storage Foundry to assign to a user or a group of users access rights to a particular storage object. A dynamic Inode allocation allows the Storage Foundry to maintain an arbitrary number of files on the volume without any special actions. This feature is essential in building large storage systems, as well as scaling large systems. One way to calculate a number for the number of Inodes is: number of Inodes is equal to maximum file size divided by size of Inode body: 2\hat{ }63/2\hat{ }8=2\hat{ }54.

An Extended Attribute (EA) assigns to a user or a group of users access rights to a particular storage object. Prior art computer systems and associated storage devices maintain a list of characteristics that are associated with a user's particular files. These are often known as attributes and comprise such things as ‘time of last access’, read and write permissions, etc. Some prior art systems provide for so called “extended attributes” in the sense that they allow a small associated storage space to be associated with user definable “attributes”. The storage system of the exemplary embodiment goes well beyond this prior art by two different measures. First, the Storage Foundry “marries” the concepts of attributes and user-selected policies. Second, the present invention stores this information, not as a limited and constrained few bytes, but rather within the file system's Inode schema. This means that there is no size limitation on resulting “attributes”. Thus attributes surpass ‘extended attributes’ to be ‘extensive attributes’. It also means that this information is readily available and securely stored in more than one location. These attributes are far broader in scope and usage than standard EA. In the IFS permission model IFS uses Windows NT like access types, but uses more extensive Access Control Entries (ACE). IFS access types include: READ/READ DIR, WRITE/CREATE FILE, READ ACL, WRITE ACL, ACL APPEND/MAKE DIRECTORY, CHANGE OWNER, REMOVE ATTRIBUTE, READ ATTRIBUTE, WRITE ATTRIBUTE, WIPES, ENABLED DEVSETS, EXECUTE/TRAVERSE, REMOVE CHILD, etc. The IFS also supports a samba module that is responsible for ACL support for Windows clients. Under some circumstances, it may be desired to insure that a duplicate copy of both the metadata and data are stored on a single device, that device being located at a physically remote location, and being remotely accessible. For example the remote copy could be accessible over a WAN or internet. This ability allows the creation and or maintenance of an inexpensive remote copy.

The Logical Volume Manager (LVM) allows the Storage Foundry to handle multiple physical partitions/extensions/drives to create single volume. Because of the IFS's “awareness” of underlying devices, it is possible to resize IFS volumes “on the fly” (not only add devices, but also to remove unreliable devices without interruption of service). Internally, IFS is aware of all devices available to its domain of use. Accordingly, it can work-around some Linux kernel limitations and accomplish the following:

Alter volume size.

Implement complex allocation policies, and mark devices offline and exclude failed devices from process without any system interruption.

Add devices to mounted and active file system without any system interruption.

The maximum number of drives IFS can handle is 65540—far beyond most physical interface limitations. At file system initialization, the system selects from pre-existing or predefined devices (arbitrarily sized partitions on an existing physical device) to place user data. Those devices can be combined into sets (using arbitrary criteria) and sets in turn can be assigned to a specific user, group, or everybody.

As implemented in the exemplary embodiment, the HSM provides an automatic and transparent way of managing data between different storage layers to meet reasonable access time requirements while minimizing the overall system cost and improving overall system reliability. Different types of revision models (per backup, per access session, per change) are supported. The HSM also supports a multi-point Restore capability. All file system changes go through a revisioning system that utilizes the following three different revision assignment schemes that, in turn, setup a granularity of change tracking. File revision selection can be changed after each backup session. All changes from one backup until another are considered as one modification. In this way the user can maintain the degree of revisions desired:

After every file is closed (all modifications of the file from it's opening until closing are considered as one modification)—this is the default case; or

After every block modification (each modification presents a new revision of the file. —this is the so-called backviews model). Note: there is a tradeoff for having a restorable revision for every revision of a file change. This tradeoff ‘cost’ is the space-capacity to store these revisions, as well as network traffic consumption to move them to the HSM subsystem.

The exemplary embodiment also supports local or remote monitoring of the system via SNMP protocol. It supports SNMP v1 (basic), SNMP v2, which offers some protection, or SNMP v3, which can handle encryption, authentication and authorization. Accordingly, administrators can monitor operation and track performance statistics. In addition, it is also possible to effect changes to the system remotely if an administrator has the proper permissions. The Storage Foundry software supports UNIX syslog functions. Remote administration is accomplished either through an SSL-capable web browser or by a command line interface over SSH. Both methods deliver strong encryption and authentication for enhanced security.

The exemplary embodiment further comprises a virtualization feature that allows the Storage Foundry to optimize the size of the volume by truncating portions of the files that have a copy in HSM. This allows the size of the volume to be virtually unlimited. This optional approach to managing storage allows every user to tune virtualization policies for different types of files. This enables the user to more effectively manage his working file set in order to achieve maximum performance.

During backup, the HSM subsystem detects the type of each processed file and uses this information together with the information on file access time provided by the IFS. This is used to implement user policy decisions on file residency. Because the SSU (see, FIG. 2) possesses all the necessary information about the volume, it can truncate any part of any file thus freeing volume space for files that are used more actively. Accordingly, the SSU implements decisions on which files, when and how much of the file (header remains on the disk to provide for quick access to the file) should be truncated. Immediately after the user or a user program requests such a “virtualized” file, the system transparently initiates its retrieval from the SSU. The system can also virtualize files using set of definable rules: for each user or group, or depending on the type of the file. For example the system can classify files as “Documents”, Programs”, “Multimedia”, “Archives”, etc. The system uses a tunable parameter such as either the age of file, or time “since last access” to the file.

The Storage Foundry can maintain multiple copies of user data on different drives (data mirroring) and use these copies in the event of a drive failure. This assures against interruption of availability in serving user requests. Such ability gives the Storage Foundry advantages over parity protected RAID type devices in that copies can be selectively created for user-selected users/directories, as opposed to being constrained to select the whole device. Additionally, automatic copying of the data, upon a device failure, occurs in a high-speed sequential transfer mode, as opposed to time-consuming parity calculations. After copying the failed area, the system is ready to handle subsequent failures without any time-consuming (risk introducing) additional actions (i.e. volume breaking/rebuilding, etc.).

Storage schemes frequently require “mirroring” in order to assure that multiple copies of a database are created so as to improve reliability. Such mirroring has been a valued storage technique for decades. Prior art storage systems typically, but not always, limit “mirroring” to like physical devices. When the mirror copy was written more-or less simultaneously it was called a synchronous mirror. When it was written asynchronously it was sometimes called a logged mirror. If the mirror was to be located in a remote location from the primary storage copy, it was often asynchronous and in some instances called a replication, or a replication mirror. The Storage Foundry analyzes mirroring needs and/or requests and implements a mirroring strategy in a completely different manner that the prior art systems. The present invention accepts a user or administrator request to “mirror” all data transfers. The present invention can also simulate physical mirroring for a particular device. Mirroring for a specific user directory, or a storage area associated with a given individual or collective user(s) are also supported. An individual user might even have several different mirroring strategies in use for managing his storage needs.

In an alternative embodiment of the Storage Foundry, the request to mirror is not required to specify destination device(s). If a request does specify a device(s), mirroring is accomplished according in a manner consistent with the prior art. If a request specifies a generic storage media, based on storage characteristic, such as monetary costs, speed, or reliability, the system will cause allocation of storage transfers to those media previously requested by the user or administrator. In the event that a user or system administrator elects to not specify a destination device in any way, the Storage Foundry determines an efficient mirroring strategy across the resources that it manages and it allocates the appropriate storage media. A request to mirror may specify the number of copies to be maintained. A portion of the copies may be designated to be stored on drives that may be directly attached, network attached, or attached via a Hierarchical Storage Management (HSM) mechanism. Additionally, the storage foundry can automatically handle mirroring without requiring any user or administrator involvement. The system of the exemplary embodiment determines and remembers the location of each copy without any user or administrator involvement. The user or administrator need only remember the file name. The storage system of the present invention further complies with any other specified, or default user policies. For example if a user or administrator selects a high availability policy, the storage system of the present invention ensures that the copies are stored on drives so that such drives are selected on physically independent adapter boards or channels.

The Storage Foundry recognizes virtually immediately when a device fails or becomes unavailable. Devices may be designated to the system of the present invention as “always available” or “temporarily available”. Devices that are “always available” are treated as having failed immediately after a standard number of attempts have been made to try to access the device. Devices that are “temporarily available” are not determined to have failed after they become unavailable. In the event that a device becomes temporarily unavailable, the storage system of the present invention will make additional resources and capabilities available. These include additional storage capacity as well as journaling capabilities. The storage system of the present invention also determines, monitors, and tracks, the status of the desired storage device. In the event the storage device, previously determined to be temporarily unavailable, becomes available, the storage system of the present invention will automatically re-locate the temporarily stored and journaled data to that device.

The storage capacity of a device that is determined by the storage system of the present invention to have “failed” is immediately replaced using storage capacity from other current storage device inventory. This means that an equal amount of device capacity is allocated. This replacement capacity could be on a single device or it could span multiple devices. Under some circumstances, it may be desired to insure that a duplicate copy of both the metadata and data are stored on a single device, that device being located at a physically remote location, and being remotely accessible. For example the remote copy could be accessible over a WAN or Internet. The system of the present invention allows the creation and or maintenance of an inexpensive remote copy.

The Storage Foundry manages multiple copies of user data during its operations. This feature is tightly coupled with LVM (logical volume manager) subsystem. The option of creating additional copies depends on file system volume and user/group policies thus providing flexibility in system tuning (performance against reliability). The IFS detects drive failures by itself and can continue it is normal operations without any interruption of service. It also automatically replicates data for the failed device.

The Storage Foundry accepts a user-supplied parameter controlling the number of synchronized copies of the data (each will be placed on a different drive). This parameter manages the level of reliability desired for a specified user (or group).

The HSM facility permits restores from automatic archives and backups under direction of a user supplied policy. In the exemplary embodiment, restores are “versioned restores,” which means that it is possible to automatically archive every file version, and have the option of recalling the specific file version that most closely corresponds to a specific date and time.

A Journaling Capability allows the Storage Foundry to maintain and guarantee its data integrity during unexpected interrupts. This is particularly true without regard to the volume size, or the size of the working file set at the moment of failure. This feature also obviates long runs of a file system check utility on system startup. It has a log-based journaling subsystem with an ability to place the journal on a dedicated device. It has a journal replay facility to commit or revert unfinished transactions during system mount.

The exemplary embodiment comprises a device WRITE cache (DWC) flushing feature. Typical modern drives have cache hardware that use volatile RAM. They respond to WRITE commands by claiming a complete transfer even though the data is in RAM and not on magnetic media. Thus, there is a period of time before cache-synchronization when the data already in the drive's possession is vulnerable to being lost if a power failure occurs before the physical media is actually updated. Many storage systems, particularly RAID, turn drive cache off thus obviating this potential problem at the expense of a performance penalty. The Storage Foundry software effectively increases performance while ensuring data consistency in the event of a power failure.

DWC flushing is built into the Journal. The Journal issues periodic commands to the drives to flush drives, thus synchronizing cache. It keeps a journal log of the data not committed to media for each drive between commands. In this fashion, the Storage Foundry derives the benefit of device WRITE caching, without the associated penalty of data loss.

DWC flushing works by using the Journal's internal checkpoints for transaction integrity. DWC flushing is closely integrated with the Journal. Transactions are considered as completed by the Journal when all blocks from the specific transaction are written to devices. The Journal tracks the successful completion of all the associated WRITEs comprising transactions at the checkpoint. Subsequently, the Journal initiates (at the same checkpoint) a flush of device write cache.

The frequency of check points is directly related to the amount of changes to disk that are committed by the host(s). It is possible to set this rate in the software, but the journal itself can adjust this rate in response to the number and timing of request host WRITEs. This automatic ability of the present invention to manage drive device WRITE flushing is unique. Current storage systems lack the “awareness” of the file system and are not cognizant of both the specific WRITE transactions and the various physical drive elements.

As a performance feature, the system administrator can specify a dedicated device for journal operations in order to take advantage of separation of journal 10 from other data traffic. Also a device selected for journaling can be fast (solid-state disk), which can greatly boost overall system performance. The Journal also supports a parameter to specify the journal's transaction flush time. A longer period allows more changes to be batched into one transaction, thus improving performance by reducing journal 10, but increases the probability to lose more changes in case of crash. A shorter period for this parameter leads to higher journal update rates, while minimizing amount of changes to be discarded in case of crashes. The Journal also supports specifying the size of the journal file. Under high loads to the file system, larger journals can temporarily store a significant number of changes. As all WRITEs must be put into the journal first, a situation can occur when the journal function can be marginalized by yet-to-be-flushed transactions. This may lead to forced transaction flushes and delays in handling of new incoming changes. The IFS employs reasonable defaults for all such parameters, and if a system administrator has specific knowledge about a usage pattern, he/she may override this default.

The exemplary embodiment has a built in load balancing mechanism that seeks to ensure that WRITEs to member drives are distributed so as to balance the system load. This automatic feature can be preempted by some specific policy selections (designating a specific drive, for example) but the feature will re-assert itself wherever possible (within a set of specific drives as a user policy, for example.)

Allocation is the process of assigning resources. When requested by a host application, the file system responds by designating a suitable number of “allocation units”, or clusters, and it starts to store data at those physical locations. In this manner, the assignment of designated areas of a disk element to particular data (files) occurs. To help manage this process, there may be a block allocation map, or bit map, representing each available block of storage on a disk element and defining whether that block is in use or free. The file system allocates space on the disk for files, cluster by cluster, and it blocks out unusable clusters, and maintains a list of unused or free areas, as well as maintaining a list of various file locations.

Some systems support preallocation. This is the practice of allocating extra space for a file so that disk blocks will physically be part of a file before they are needed. Enabling an application to preallocate space for a file guarantees that a specified amount of space will be available for that file, even if the file system is otherwise out of space. Note, that the entire process of allocation and preallocation occurs in a constrained scope, or microscopic sense, and it does so with no explicit user involvement. Also, the choices made by the allocation algorithm can have a significant effect on the future efficiency of the host application, simply because of the immediate proximity of where data is allocated and stored within the file system and the time to effect transfers to those physical locations.

In an embodiment of the present invention, a Storage Foundry implements diverse allocation strategies across multiple physical drive elements. This capability flows from merging the file system and the volume manager into one interwoven unit of software. In this way, the same software point that is responsible for block allocation, is “aware” of the number, size, and characteristics of the multiple physical drive elements. Using a LVM (logical volume manager), an embodiment of the present invention supports four methods of data allocation: (1) preallocation (all blocks for one file are allocated sequentially on one drive), (2) default allocation (the IFS system may assign block to one or more drives based on automatic load balancing techniques), (3) policy allocation (the IFS system may assign blocks to one or more drives based on user policies and performance demands), and (4) striping (blocks stripe across multiple devices in order to take advantage of system bus bandwidth) policies. The system administrator may also specify a performance optimization parameter, which controls how large a block region should be for preallocation.

The Storage Foundry can separate metadata from file data onto different devices. Using this ability a very high performance can be achieved by creating file system volumes using a Solid State Disk as a metadata device and using magnetic disks as a file data device. In this manner performance from the solid-state drive reduces the metadata access times and accelerates overall throughput. In addition, there are data security benefits that may be derived from the separation of data and metadata.

The Large File Support (LFS) technology allows the Storage Foundry software to maintain large files with sizes more than 4 GB. This implementation optimizes performance in large file transfers. For example and without limitation, IFS is a full 64-bit file system and is capable of handling files as large as 2A63=8 exabytes. All internal data structures (based on B*Trees) and algorithms are designed in order to support access to large files. It is also possible to reach beyond the maximum accessible file offset up to 16TB using a 4K-page size.

In order to accelerate the retrieval of virtualized files, and to accelerate normally slow tape operations, the Storage Foundry can request more data from the SSU than the application has actually requested (Read Ahead). This pre-fetch operation has the twin benefit of more efficient tape utilization on the SSU side, and faster data access times on the NAS server side.

In order to accelerate access to a virtualized entry of a file system, the Storage Foundry can optionally leave on disk an initial part of the file during the virtualization process. This header will be immediately accessible by the calling application, while the virtualized part of the file will be in the process of retrieval from SSU.

Semaphores are a trusted prior art device to manage the process of a communications transfer. In one embodiment of the present invention, semaphores are used in conjunction with shared memory in a novel way to manage the transfer large blocks of memory from the Linux kernel to the user space. Specifically, these transfers are achieved without any copying nor without Direct Memory Access (DMA). The method creates “a window into kernel memory” where a user process is notified via semaphore. The data is extracted from the window (organized by using shared memory) and the kernel notified that the transfer is has been completed. In this manner, a repeat number of large blocks of memory are moved from the kernel to the user space in a relatively short period of time.

As previously described, the Storage Foundry integrates the file system with functions of a volume manager. This functional combination is then layered by an HSM facility. The result is an “Overview Architecture” that is capable of integrating a wide perspective of the required storage transfers and the physical storage elements. This combination makes possible a range of previously unavailable storage management functions such as:

Live Expansion/Contraction of Storage Volumes.

Multi Copy Data Mirroring.

Automatic Backup, and Archiving.

Automatic Virtualization.

Extensive User Policy Control.

HSM Virtualization and Prefetch Facilities.

Automatic Load Balancing.

Device Write Cache Flushing.

Extensive Journaling Capabilities.

Dynamic Inode Allocation.

Large File Support.

The Storage Foundry system supports a wide scope of applications and usage. These range from conventional NAS and NAS Gateway applications, to Application Specific storage, and unique storage applications. In addition, the Storage Foundry is very well suited for Blade Server systems as well as for Fixed Content Storage environments.

The Storage Foundry operates within the envelope of a conventional NAS file server or appliance. It responds as a dedicated file server appliance that can reside on an enterprise local area network (LAN), or be accessible over the Internet, or Intranet, via TCP/IP protocol.

It provides shared disk space to multiple users in a company or work group environment as such a server. NAS provides less expensive file sharing, less day-to-day administration, and more secure technology, than a general-purpose server does. The Storage Foundry supports both Unix and Windows environments via NFS and CIFS file transfers.

While operating as a conventional NAS appliance, the Storage Foundry is still capable of providing all of the features and benefits previously described above.

A NAS device that uses a block addressable storage unit via iSCSI protocol over a TCP/IP connection is sometimes called a NAS Gateway. In truth, it is not much of a gateway at all. While it does introduce a sorely needed backup capability to NAS and it does afford a type of “centralization” for NAS file data to be stored on a SAN, it provides no additional consolidation benefits.

It is possible to connect the Storage Foundry to a SAN in such a fashion, using the SAN iSCSI TCP/IP connection as a storage target, however, there is precious little to be gained from such an implementation. This is true because the Storage Foundry already provides extensive backup, archiving, and centralized services.

In summary, the Storage Foundry provides all the advantages of as a NAS Gateway without the added HBA hardware and cabling costs and concerns.

A server arrangement that incorporates multiple server-processors, like blades on a fan, in order to reduce rack space requirements, streamline server management, and vastly simplify installing and maintaining servers, is called a Blade Server.

Blade Servers provide multiple processors, redundant power, air handling services, and are incorporated and packaged as one enclosure. They can dramatically reduce the amount of data center floor space required for a given number of servers, as well as greatly simplify the tangle of cables that are associated with multi server installations. The reduced space requirements and easy of remote administration accrue for both field offices and high-density data centers.

The remote administration capabilities and ease of re-provisioning of storage elements supported by the Storage Foundry, and the simplicity of NAS communication, make it the superior storage component for a blade server. The Storage Foundry software can execute on a single blade and be made accessible to other blade processors. The ease of managing drive expansions, contractions, and replacements, adheres to the centralized philosophy inherent in most blade server architectures,

While operating in a blade server environment, the Storage Foundry is still capable of providing all of the features and benefits previously described above.

A storage system that supports storing group application specific or enterprise wide application specific data into one segmented storage area is typically called Application Specific Storage. In this manner all accounting data, for example, could be concentrated in one storage area and programs that use this data could obtain it centrally. In addition, any facility physical security could be applied at one central point. Industry attempts to implement Application Specific Storage have been, at best, unwieldy.

The integration of the file system and volume manager by the Storage Foundry software means that this combined software is cognizant of specific storage hardware throughout the process of each data transfer. This means that it is not only possible, but also easy to implement Application Specific Storage when using the Storage Foundry. All the administrator needs to do is to define a device set of drives, called ‘accounting’ perhaps, that can be reserved for a group of permissioned users. Regardless of the physical location of the user, all TCP/IP transfers to this defined device set would be routed to the same physical device(s).

If the administrator required a mirrored copy—or remote mirrored copy—of this data, it could be automatically engaged using the other services of the Storage Foundry.

While operating as application specific storage, the Storage Foundry is still capable of providing all of the features and benefits previously described above.

A storage system that is tuned, tailored, dedicated, or unique to a specific application or storage task, is typically referred to as a Unique Storage Application. Since the core of the Storage Foundry use Data Foundation's interwoven file system and volume manager software, this makes the Storage Foundry a prime candidate for a specific or unique adaptation to such a storage task. For example, the requirement of storing a video property at a remote site (hotel, cable front end, or viewer's home) represents a significant risk and an impediment to business. Encryption services help but are not, by themselves, satisfactory. As computer systems were made to read and to copy, it is impossible to stop a party with even slight interest from copying a property. In an alternate embodiment of the Storage Foundry, a storage system uses several physical devices and it is not required to store metadata with data on the same device. This storage system provides an extremely high level of data security to this video server application because a standard copy command would not be executed by the storage system. Only the storage software would be able to read the data properly.

A storage device that is optimized to support various storage deposits of fixed storage content units and optimize that content in terms of availability, content management, and streaming usage, is called a Fixed Content Storage device (or sometimes Content Addressed Storage device). Such a system could be used for the distribution of audio books, music recordings, sporting events, full-length movies, TV programs, or other intellectual property. The characteristics of a fixed content storage domain are fourfold: (1) the intellectual property represents a long-term value to an organization, (2) the storage content does not change with time, (3) the owner or licensee of this property seeks to monetize the value of the property via broad, fast, and reliable access, and (4) the property is secure from unauthorized access or copying. The Storage Foundry system is uniquely qualified to serve as a Fixed Content Storage system. The features of mirrored access, HSM virtualization, self managed archiving, and storage across different device types (solid state, magnetic, tape), make the Storage Foundry device a particularly well featured and cost effective solution. While operating in a fixed content storage environment, the Storage Foundry is still capable of providing all of the features and benefits previously described above.

A storage foundry has now been described. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A storage foundry comprising:
a processor, the processor adapted to operate software programs comprising a Data Protection Manager (DPM), a Data Organization Manager (DOM), and a Data Delivery Manager (DDM);
one or more storage devices, wherein the data storage devices received instructions from the processor, and wherein:
the DDM is adapted to manage the DOM and DPM and to track and manage individual data accesses to the one or more storage devices;
the DPM is adapted to communicate with the DDM and to protect data stored in the storage foundry; and
the DOM is adapted to communicate with the DDM and to monitor and retain metrics relating to the status of the storage devices.
